(19) United States
(12) Patent Application Publication
(10) Pub. No.: US 2004/0040422 A1
(43) Pub. Date: Mar. 4, 2004

(54) Sleeve form spanner

(76) Inventor: Ping-Nan Chuang, Taichung (TW)

Correspondence Address: Ping-Nan Chuang, 235 Chung - Ho, Box 8-24, Taipei, TW

(21) Appl. No.: 10/233,831

(22) Filed: Sep. 3, 2002

(51) Int. Cl. B25B 23/16

(52) U.S. Cl. 81/177.2

(57) ABSTRACT

A sleeve form spanner comprises a spanner body and a connecting unit. One end of the spanner body has a handle for being held by a user and another end thereof is a connecting head. One lateral side of the connecting head is formed with a pivotal end. The pivotal end is concave to be as a pivotal portion for connecting the connecting unit. The connecting unit is a block body. A connecting rod and a plurality of connecting shafts are protruded from the connecting unit. The connecting shafts have various configurations for suiting various sleeves to be connected; and the connecting rod is engaged to the pivotal portion of the pivotal end. Thereby, the user prepares only one spanner body, while a variety of tools can be used by the spanner.

### FIELD OF THE INVENTION

The present invention relates to spanners, and particularly to a spanner body which has a plurality of connecting shafts for suiting various sleeves of tools.

### BACKGROUND OF THE INVENTION

The sleeve form spanner has a head. The head has a connecting shaft for connecting a sleeve which is then connected to a screw or the connecting shaft is directly connected to a screw means. Thereby, the user may screw or release a screw means conveniently. However, in the prior art, there is only one connecting shaft and the connecting shaft has a fixed form. Thus a sleeve form spanner is suitable for only one form of tool. If it is desired to operation a sleeve or tool of another form, the connecting shaft is necessary to be updated.

Furthermore, it is often that the sleeve can not match the connecting shaft and thus an adaptor rod is necessary to match the two components. However, the operation is inconvenient and much time is consumed in the updating operation. Besides, the cost is increased.

Moreover, the center axis of the connecting shaft is aligned to the sleeve, and thus the screws not aligned to the axis can not be operated. This is also a disadvantage of this prior art design.

### SUMMARY OF THE INVENTION

Accordingly, the primary object of the present invention is to provide a sleeve form spanner, wherein the connecting shafts on the connecting unit have various configurations, and therefore, the user need only prepare only one spanner body, while a variety of tools can be used by the spanner.

To achieve above mentioned object, the present invention provide a sleeve form spanner comprises a spanner body and a connecting unit. One end of the spanner body has a handle for being held by a user and another end thereof is a connecting head. One lateral side of the connecting head is formed with a pivotal end. The pivotal end is concave to be as a pivotal portion for connecting the connecting unit. The connecting unit is a block body. A connecting rod and a plurality of connecting shafts are protruded from the connecting unit. The connecting shafts have various configurations for suiting various sleeves to be connected; and the connecting rod is engaged to the pivotal portion of the pivotal end. Thereby, the user need only prepare only one spanner body, while a variety of tools can be used through the spanner.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an exploded schematic view of the present invention.

FIG. 3 is a schematic view showing one operation of the present invention.

FIG. 4 is a schematic view showing another operation of the present invention.

FIG. 5 shows another embodiment of the present invention.

### DETAILED DESCRIPTION OF THE PREFERRED EMBODIMENTS

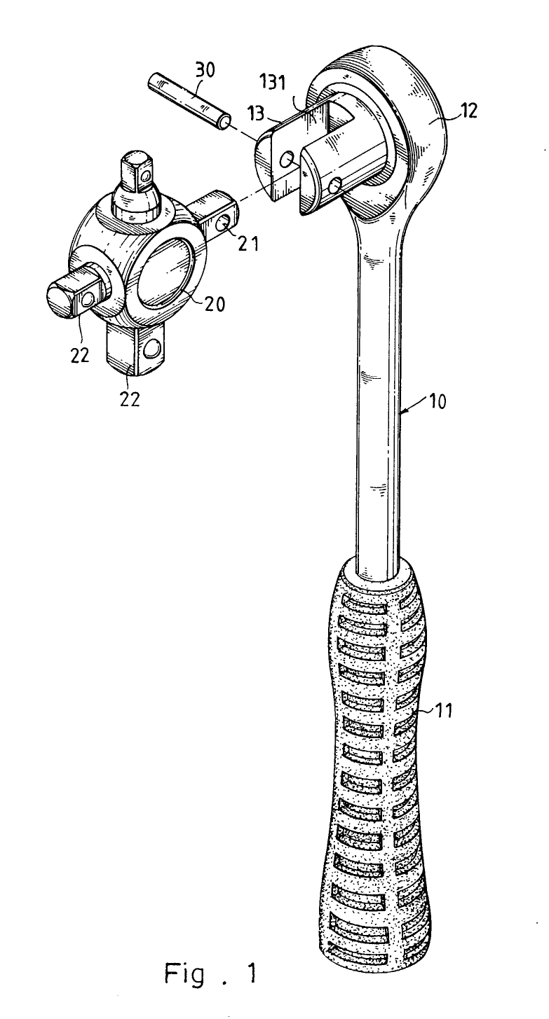

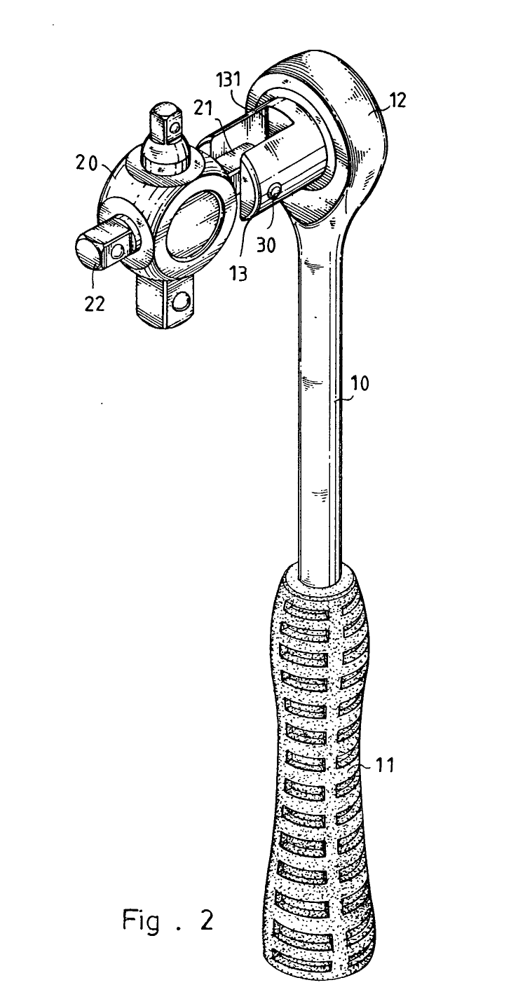

Referring to FIGS. 1 to 5, the sleeve form spanner of the present invention comprises a spanner body 10 and a connecting unit 20.

The spanner body 10 is a long rod. One end of the spanner body 10 has a handle 12 for being held by the user and another end thereof is a connecting head 12. One lateral side of the connecting head 12 is formed with a pivotal end 13. The pivotal end 13 is concave to be as a pivotal portion 131 for connecting the connecting unit 20.

The connecting unit 20 is a block body. A connecting rod 21 and a plurality of connecting shafts 22 are protruded from the connecting unit 20. The connecting unit 20 and the connecting shafts 22 are spaced with an equal angle. The connecting shafts 22 have various configurations for suiting the requirements of tools to be connected. The connecting rod 21 is exactly engaged to the pivotal portion 131 of the pivotal end 13. A positioning rod 30 inserts through the pivotal end 13 and the connecting unit 20, while the connecting unit 20 can rotate along the pivotal end 13 through an angle. The connecting shafts 22 have various configurations for suiting the configurations of tools to be connected.

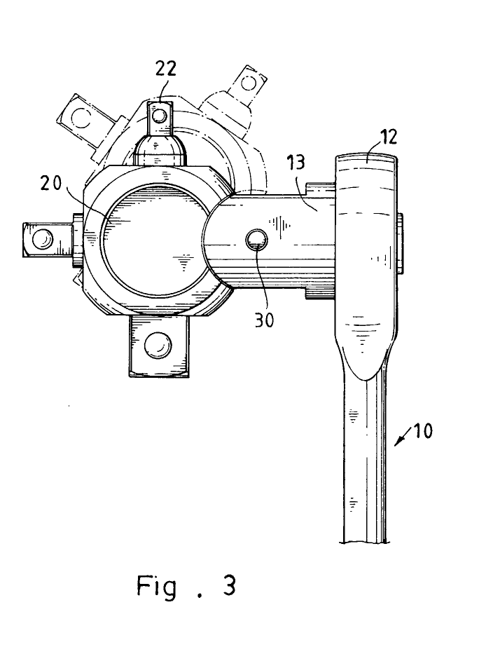

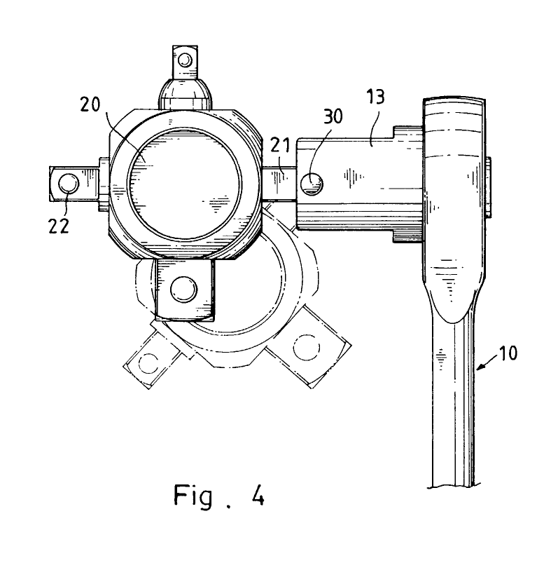

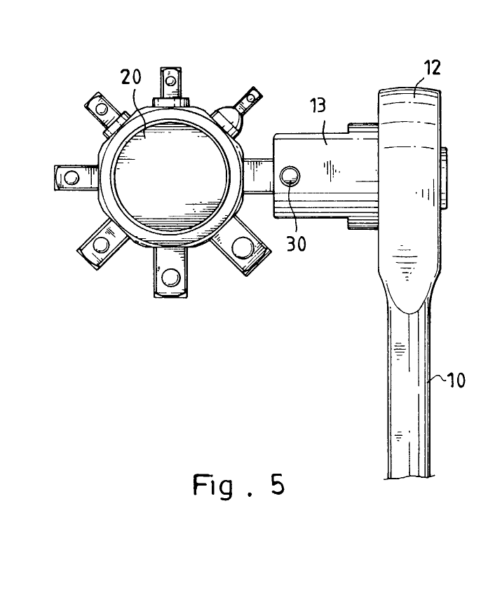

Thereby, the applications of the spanner body 10 are widened. With reference to FIGS. 3 and 4, the spanner body 10 may rotate the connecting unit 20 through a predetermined angle. Therefore, the user can adjust the angle between the sleeve and a screw so that the user can operate with a higher efficiency. Furthermore, the connecting shafts 22 on the connecting unit 20 may have various configurations, while those shown in FIG. 5 is only one example, other modifications and variations from those shown in FIG. 5 can be performed within the spirit and scope of the present invention.

Therefore, by the present invention, the user need prepare only one spanner body 10, while a variety of tools can be used by the spanner.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A sleeve form spanner comprising a spanner body and a connecting unit; one end of the spanner body having a handle for being held by a user and another end thereof being a connecting head; characterized in that:
one lateral side of the connecting head is formed with a pivotal end; the pivotal end is concave to be as a pivotal portion for connecting the connecting unit; the connecting unit is a block body; a connecting rod and a plurality of connecting shafts are protruded from the connecting unit; the connecting shafts have various configurations for suiting various sleeves to be connected; the connecting rod is engaged to the pivotal portion of the pivotal end.

2. The sleeve form spanner as claim in claim 1, wherein the connecting unit is rotatable with respect to the spanner body.
